(19) United States
(12) Patent Application Publication
(10) Pub. No.: US 2011/0269446 A1
(43) Pub. Date: Nov. 3, 2011

(54) METHOD FOR REMOTELY CONTROLLING STATUS OF SMART PHONE, SMART PHONE AND COMPUTER READABLE MEDIUM

(75) Inventor: Gary Kung, Santa Ana, CA (US)

(73) Assignee: I/O INTERCONNECT, LTD., Santa Ana, CA (US)

(21) Appl. No.: 13/095,011

(22) Filed: Apr. 27, 2011

Related U.S. Application Data
(60) Provisional application No. 61/329,450, filed on Apr. 29, 2010.

(51) Int. Cl. H04W 4/12

(52) U.S. Cl. 455/419

(57) ABSTRACT

In an exemplary method for remotely controlling status of a smart phone, a message is remotely sent to the smart phone, the smart phone monitors the content of the message and then is controlled to be set in a target status when the content of the message contains a sequence matched with the target status. For example, the smart phone can be controlled to switch from silent mode to ring mode, which facilities the user to quickly find his/her smart phone previously being set in the silent mode.

### CROSS-REFERENCE TO RELATED APPLICATION

This application claims the priority benefit of U.S. Provisional Application Ser. No. 61/329,450, filed on Apr. 29, 2010. The entirety of the above-mentioned patent application is incorporated herein by reference and made a part of this specification.

### FIELD OF THE INVENTION

The present invention generally relates to smart phones, and more particularly to a method for remotely controlling statuses of a smart phone, a smart phone and a computer readable medium.

### BACKGROUND OF THE INVENTION

Smart phones are the next generation in cellular telephony. With extraordinary computing power, built-in programmable graphics, and various communication options, smart phones can provide a convenient and powerful mobile user interface for many intelligent embedded devices. Individuals can use a smart phone to perform activities such as connecting to security systems, industrial controllers, access-control systems, medical devices, environmental systems, and other systems.

Generally, the smart phone can be set in various types of statuses, for example, can be set in a silent mode and in this situation the smart phone would not produce a ring tone or vibrate for a received message or an incoming call. The smart phone also can be set in a vibrate-only mode, a ring-only mode, a vibrate-then-ring mode, or a vibrate-and-ring mode, and so on. Moreover, the ring tone may have different volumes, and the types thereof are diversified. When the smart phone is in use, it is usually needed to switch the statuses of the smart phone according to the need of different scenes. However, for example, after the smart phone is set in the silent mode, it is most troublesome that once the smart phone could not be found, even if dialing a call to the smart phone, the user still could not quickly find the location of the smart phone because of the smart phone is set in the silent mode.

### SUMMARY OF THE INVENTION

Accordingly, an objective of the present invention is to provide a method for remotely controlling status of a smart phone, so as to improve the use convenience of the smart phone.

Another objective of the present invention is to provide a smart phone with improved use convenience.

Still another objective of the present invention is to provide a computer readable media stored with a program to facilitate the improvement of use convenience for the smart phone.

In one aspect, a method for remotely controlling status of smart phone in accordance with an embodiment of the present invention includes steps of: remotely sending a message to the smart phone; monitoring the content of the message by the smart phone; and controlling the smart phone to be set in a target status when the content of the message contains a sequence matched with the target status.

In one embodiment, the step of controlling includes switching the smart phone from a current status to the target status when the sequence is matched with the target status rather than the current status.

In one embodiment, the sequence includes numerals, alphabets, symbols or any one of combinations thereof.

In one embodiment, the target status is one of the group consisting of a silent mode, a vibrate-only mode, a ring-only mode, a vibrate-and-ring mode and a vibrate-then-ring mode.

In one embodiment, the method further includes steps of: providing a setting interface by the smart phone; and editing sequences in the setting interface respectively matched with different statuses of the smart phone.

A smart phone in accordance with an embodiment of the present invention includes a storage device, a processor, and a program stored in the storage device and being executable by the processor to monitor the content of a message received by the smart phone whether contains a sequence matched with one of statuses of the smart phone and thereby trigger the smart phone to be set in a target one of the statuses if the content of the message contains the sequence.

In one embodiment, the program is executable by the processor to further provide a setting interface for allowing a user to edit different sequences respectively matched with the statuses of the smart phone.

A computer readable medium in accordance with an embodiment of the present invention is stored with a program for performing a method for controlling status of a smart phone. The method includes steps of: monitoring the content of a received message of the smart phone; and controlling the smart phone to be set in a target status when the content of the message contains a sequence matched with the target status.

In summary, owing to the smart phone can monitor the content of the received message and thereby switch from the current status (e.g., silent mode) to the target status (e.g., ring-only mode) if the content of the received message contains the sequence matched with the target status, which facilitates the user to look for his/her smart phone previously being set in the silent mode. Of course, the user can remotely switch the smart phone to any target status according to the actual needs by sending a message containing a particular sequence. As a result, the use convenience of the smart phone is improved, achieving the purpose of developing the present invention.

### BRIEF DESCRIPTION OF THE DRAWINGS

The above objectives and advantages of the present invention will become more readily apparent to those ordinarily skilled in the art after reviewing the following detailed description and accompanying drawings, in which:

FIG. 1 is a schematic block diagram of a smart phone in accordance with an embodiment of the present invention;

FIG. 2 is a schematic view of a setting interface provided by the smart phone in FIG. 1; and

FIG. 3 is a flowchart of a method for remotely controlling status of the smart phone of FIG. 1 in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

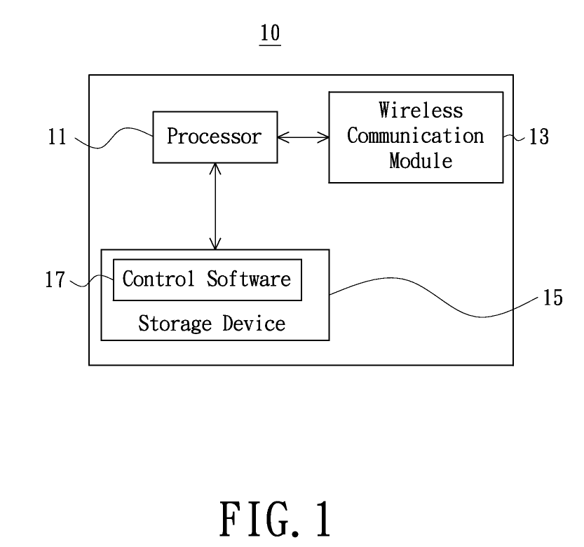

Referring to FIG. 1, a schematic block diagram of a smart phone in accordance with an embodiment of the present invention is shown. As illustrated in FIG. 1, the smart phone 10 includes a processor 11, a wireless communication module 13 and a storage device 15, and moreover a software application program e.g., control software 17 is installed in the storage device 15. The amount of the processor 11 is not limited to one, and may be more than one. The storage device 15 is for example, but not limited to, a flash memory or micro hard-disk. When the control software 17 is executed by the processor 11, the smart phone 10 can monitor the content of a received message and thereby triggers the smart phone 10 to be set in a target status when the content of the received message contains a sequence matched with the target status. In an embodiment, the processor 11 is triggered to execute the control software 17 when the wireless communication module 13 is receiving a message. In other embodiment, the processor 11 may continuously execute the control software 17 once the smart phone 10 is booted up.

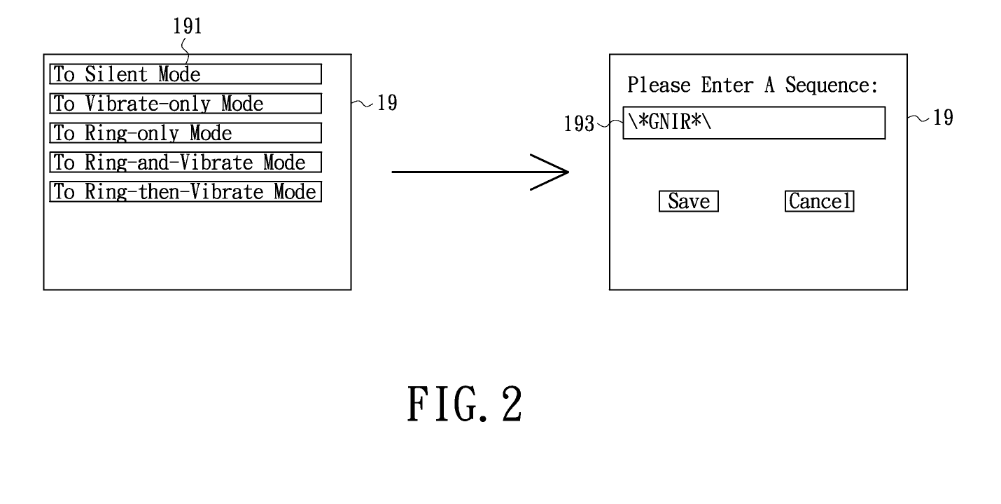

Moreover, when a user wants to edit sequences respectively matched with different statuses of the smart phone 10, the user can trigger (e.g., by clicking an icon) the processor 11 to execute the control software 17 so as to provide a setting interface 19. As illustrated in FIG. 2, the setting interface 19 provide multiple options 191 for the user to edit sequences respectively matched with different statuses of the smart phone 10. For example, the statuses of the smart phone 10 may include, but not limited to, a silent mode, a vibrate-only mode, a ring-only mode, a ring-and-vibrate mode, and a ring-then-vibrate mode. When the user selects the option of “To Ring-only Mode”, the setting interface 19 may show the text “Please Enter A Sequence”, an input field 193 and some relevant buttons such as “Save”, “Cancel”. For example, the user can input “\*GNIR*\” in the input field 193 and save it as the sequence for switching to the ring-only mode. It is indicated that, the sequence matched with any one of the statuses is not limited to include the symbols such as “\”, “*” and alphabets such as “G”, “N”, “I”, “R”, and may be only comprised of numerals (e.g., “0” to “9”), etc.), alphabets (e.g., “a” to “z”), or symbols (e.g., “/”, “\”, “*”, “&”, spaces, delimiters and Chinese characters, etc.). In addition, each sequence may be any one of combinations of characters including the numerals, the alphabets and the symbols. In addition, it can be understood that, the sequences for the respective statuses of the smart phone 10 can be initially set by the manufacturer.

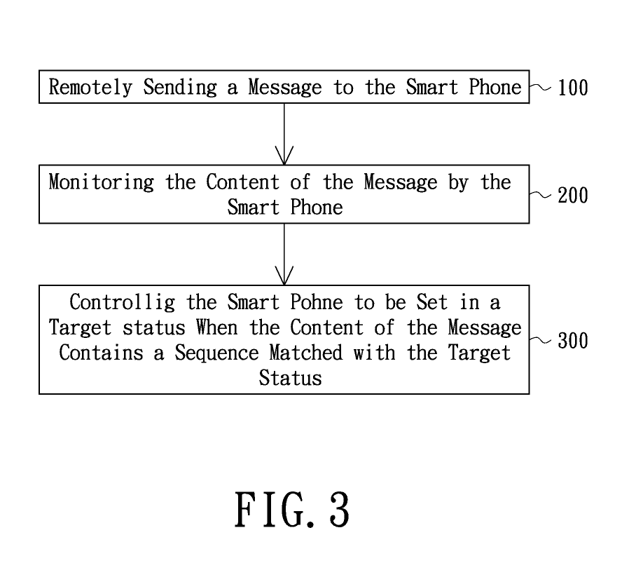

Referring to FIGS. 1 through 3, FIG. 3 showing a flowchart of a method for remotely controlling status of the smart phone 10 in accordance with an embodiment of the present invention. As illustrated in FIG. 3, the exemplary method primarily includes steps 100 to 300.

In particular, in the step 100, a message is expected to be remotely sent by a user to the smart phone 10 if the user wants to switch the smart phone 10 to a target status e.g., a ring-only mode. In the illustrative embodiment, the message can be sent out through a text message function or an E-mail function of a mobile phone (for example, but not limited to, another smart phone). Moreover, according to the illustration of FIG. 2, the content of the message ought to contain the sequence of “\*GNIR*\”, so as to switch the smart phone 10 to the ring-only mode.

In the step 200, the processor 11 executes the control software 15 to monitor the content of the message by the smart phone 10 to determine the message whether contains a sequence matched with one of the statuses.

In the step 300, if the content of the message, is determined, contains the sequence matched with one of the statuses, the smart phone 10 is controlled to be set in the target status. Herein, the sequence is matched with the target status and it is assumed that a current status of the smart phone 10 is a silent mode, if the sequence is “\*GNIR*\”, the target status correspondingly is the ring-only mode, so that the smart phone 10 is triggered to switch from the silent mode to the ring-only mode. It can be understood that, in a case of the current status also is the ring-only mode, the status would be kept unchanged when the received message containing the sequence of “\*GNIR*\”.

Furthermore, since the control software 15 can be executed by the processor 11 to provide the setting interface 19, the above method may further include a step of: editing sequences in the setting interface 19 respectively matched with different statuses of the smart phone 10.

In addition, the above control software 17 can be stored as a program into a computer readable medium and is executable by the processor 17 to perform the above exemplary method for remotely controlling status of a smart phone.

Sum up, in the various embodiments of the present invention, owing to the smart phone can monitor the content of the received message and thereby switch from the current status (e.g., silent mode) to the target status (e.g., ring-only mode) if the content of the received message contains the sequence matched with the target status, which facilitates the user to look for his/her smart phone previously being set in the silent mode. Of course, the user can remotely switch the smart phone to any target status according to the actual needs by sending a message containing a particular sequence. As a result, the use convenience of the smart phone is improved, achieving the purpose of developing the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for remotely controlling status of a smart phone, comprising steps of:
remotely sending a message to the smart phone;
monitoring the content of the message by the smart phone; and
controlling the smart phone to be set in a target status when the content of the message contains a sequence matched with the target status.

2. The method as claimed in claim 1, wherein the step of controlling comprises:
switching the smart phone from a current status to the target status when the sequence is matched with the target status rather than the current status.

3. The method as claimed in claim 1, wherein the sequence comprises numerals, alphabets, symbols or any one of combinations thereof.

4. The method as claimed in claim 1, wherein the target status is one of the group consisting of silent mode, vibrate-only mode, ring-only mode, vibrate-and-ring mode and vibrate-then-ring mode.

5. The method as claimed in claim 1, further comprising steps of:
providing a setting interface by the smart phone; and
editing sequences in the setting interface respectively matched with different statuses of the smart phone.

6. A smart phone comprising:
a storage device;
a processor; and
a program stored in the storage device and being executable by the processor to monitor the content of a message received by the smart phone whether contains a sequence matched with one of statuses of the smart phone and thereby trigger the smart phone to be set in a target one of the statuses if the content of the message contains the sequence.

7. The smart phone as claimed in claim 6, wherein the program is executable by the processor to further provide a setting interface for allowing a user to edit different sequences respectively matched with the statuses of the smart phone.

8. A computer readable medium stored with a program for performing a method for controlling status of a smart phone, the method comprising steps of:
monitoring the content of a received message of the smart phone; and
controlling the smart phone to be set in a target status when the content of the message contains a sequence matched with the target status.

9. The computer readable medium as claimed in claim 8, wherein the step of controlling comprises:
switching the smart phone from a current status to the target status when the sequence is matched with the target status rather than the current status.

10. The computer readable medium as claimed claim 8, wherein the sequence comprises numerals, alphabets, symbols or any one of combinations thereof.

11. The computer readable medium as claimed in claim 8, wherein the target status is one of the group consisting of silent mode, vibrate-only mode, ring-only mode, vibrate-and-ring mode and vibrate-then-ring mode.

12. The computer readable medium as claimed in claim 8, further comprising steps of:
providing a setting interface by the smart phone; and
editing sequences in the setting interface respectively matched with different statuses of the smart phone.
